(19) United States
(12) Patent Application Publication
(10) Pub. No.: US 2025/0053010 A1
(43) Pub. Date: Feb. 13, 2025

(54) IMAGE DISPLAYING DEVICE AND IMAGE DISPLAYING METHOD

(71) Applicant: Sony Interactive Entertainment Inc., Tokyo (JP)

(72) Inventor: Makoto Koizumi, Saitama (JP)

(73) Assignee: Sony Interactive Entertainment Inc., Tokyo (JP)

(21) Appl. No.: 18/721,722

(22) PCT Filed: Dec. 21, 2022
(86) PCT No.: PCT/JP2022/047174

§ 371 Date: Jun. 19, 2024

(30) Foreign Application Priority Data
Jan. 17, 2022 (JP) 2022-005236

(51) Int. Cl. G02B 27/01; G02B 27/00

(52) U.S. Cl. CPC G02B 27/0172; G02B 27/0093

(57) ABSTRACT

An image displaying device of the present invention includes a central image generation unit that generates a central image representative of a central portion of a display image on an image plane, a peripheral image generation unit that generates a peripheral image representative of a region of the display image on the outer side of the central image, a central image outputting unit that displays the central image by a laser scanning method of performing two-dimensional scanning with laser light representative of a pixel by reflection of a mirror (222) to project an image, a peripheral image outputting unit (234) that displays the peripheral image, and an image synthesis unit (236) that synthesizes the central image and the peripheral image to form an image to be visually recognized.

### TECHNICAL FIELD

The present invention relates to an image displaying device and an image displaying method for allowing a user to visually recognize an image.

### BACKGROUND ART

An image displaying system which allows a target space to be enjoyed from a free point of view has come into widespread use. For example, there has been developed a system in which a panoramic screen image is displayed on a head-mounted display and, when a user who is wearing the head-mounted display turns his/her head, then a panoramic image is displayed according to a line-of-sight direction. Using the head-mounted display makes it possible to enhance the sense of immersion in a screen image and enhance the operability of an application such as a game as well. There has also been developed a walkthrough system which allows a user who is wearing a head-mounted display to virtually walk around in a space displayed as a screen image by physically moving.

To enhance the quality of screen image experience, it is demanded to represent an image in a wide visual field in high definition. However, as the resolution or the visual field angle expands, the data size of an image to be processed increases, and time is required for processing and transfer of the data. As a result, a delay in displaying the data is likely to occur. Therefore, proposed is a technology by which, utilizing such a visual characteristic of a human being that visual acuity decreases as the point of view moves from the center to an end of a visual field, a difference is provided in resolution of an image between the central region and the outside region such that wasteful processing is reduced while the picture quality in visual recognition is maintained (for example, refer to PTL 1)].

### CITATION LIST

### Patent Literature

[PTL 1] U.S. Pat. No. 10,140,695

### SUMMARY

### Technical Problem

It is a normally common subject to make it possible, not only in the field of a head-mounted display but also in the field of the image displaying technology, to display an image of a wide visual field and high definition with low delay. For example, in a case of the technology of PTL 1, providing different displays for a central region and the remaining region and providing a clear difference in display resolution between the regions facilitate appropriate distribution of processing resources. Meanwhile, since images that are represented individually and have resolutions different from each other are synthesized, there possibly occurs a problem in that a boundary line looks unnatural, and this provides strangeness to the user. To solve this problem, one possible method is to connect the resolutions smoothly to each other on data. However, this additionally requires image processing. Especially, in a case where a high-resolution region is moved in an interlocked relation with the gaze point of the user, unignorable processing time is expected to occur for cutting of a varying region or for resolution adjustment.

The present invention has been made in view of such a problem as described above, and it is an object of the present invention to provide a technology that can display an image of high definition and a wide visual field to be visually recognized easily without causing a feeling of strangeness.

### Solution to Problem

A certain mode of the present invention relates to an image displaying device. The image displaying device includes a central image generation unit that generates a central image representative of a central portion of a display image on an image plane, a peripheral image generation unit that generates a peripheral image representative of a region of the display image on an outer side of the central image, a central image outputting unit that displays the central image by a laser scanning method of performing two-dimensional scanning with laser light representative of a pixel by reflection of a mirror to project an image, a peripheral image outputting unit that displays the peripheral image, and an image synthesis unit that synthesizes the central image and the peripheral image to form an image to be visually recognized.

Another mode of the present invention relates to an image displaying method. The image displaying method includes a step of generating a central image representative of a central portion of a display image on an image plane, a step of generating a peripheral image representative of a region of the display image on an outer side of the central image, a step of displaying the central image by a central image outputting unit of a laser scanning type of performing two-dimensional scanning with laser light representative of a pixel by reflection of a mirror to project an image, a step of displaying the peripheral image by a peripheral image outputting unit, and a step of synthesizing the central image and the peripheral image to form an image to be visually recognized.

It is to be noted that also any combination of the components described above and representations of the present invention where they are converted between a method, a device, a system, a computer program, a recording medium on which the computer program is recorded, and so forth are effective as modes of the present invention.

### Solution to Problem

With the present invention, it is possible to allow an image of high definition and a wide visual field to be visually recognized readily without causing a feeling of strangeness.

### BRIEF DESCRIPTION OF DRAWINGS

FIG. 1 depicts views illustrating a relation between a visual characteristic of a human being and a displaying format of the present embodiment.

FIG. 2 depicts views illustrating a relation between a displaying mechanism of a laser scanning type adopted in the present embodiment and a region on an image.

FIG. 3 is a view depicting an example of an appearance of a head-mounted display of the present embodiment.

FIG. 4 is a diagram depicting a configuration of an internal circuit of the head-mounted display of the present embodiment.

FIG. 5 is a diagram depicting a configuration of functional blocks of the head-mounted display of the present embodiment.

FIG. 6 depicts views schematically illustrating a change in a central image and a peripheral image with respect to a movement of a gaze point in the present embodiment.

FIG. 7 depicts views illustrating a change of the resolution with respect to the size of the central image in the present embodiment.

FIG. 8 is a flow chart illustrating a processing procedure when the head-mounted display of the present embodiment displays an image.

FIG. 9 is a view depicting an example of a structure of an image synthesis unit that synthesizes a central image and a peripheral image to form an image to be visually recognized in the head-mounted display of the present embodiment.

FIG. 10 is a view depicting another example of a structure of an image synthesis unit that synthesizes a central image and a peripheral image to form an image to be visually recognized in the head-mounted display of the present embodiment.

FIG. 11 is a view depicting a further example of a structure of an image synthesis unit that synthesizes a central image and a peripheral image to form an image to be visually recognized in the head-mounted display of the present embodiment.

FIG. 12 is a view depicting a still further example of a structure of an image synthesis unit that synthesizes a central image and a peripheral image to form an image to be visually recognized in the head-mounted display of the present embodiment.

FIG. 13 is a view depicting a yet further example of a structure of an image synthesis unit that synthesizes a central image and a peripheral image to form an image to be visually recognized in the head-mounted display of the present embodiment.

### DESCRIPTION OF EMBODIMENT

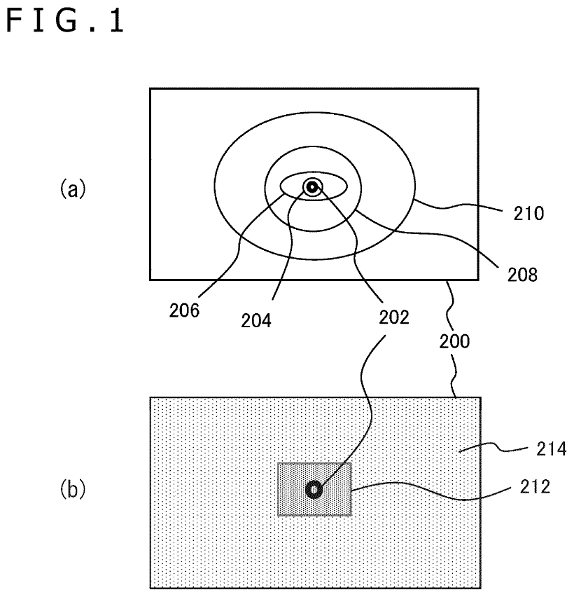

FIG. 1 depicts views illustrating a relation between a visual characteristic of a human being and a displaying format of the present embodiment. First, it is assumed that, in an image plane 200 depicted in (a), a gaze point 202 of a user indicated by a round mark is in the proximity of the center. As a common visual characteristic of a human being, a region 204 corresponding to a visual field within 5° with respect to a line of sight from the pupil toward a gaze point taken as a central axis is called a discriminative visual field, and a visual function such as visual acuity is excellent in the region 204. Further, a region 206 corresponding to a visual field within approximately 30° in the horizontal direction and approximately 20° in the vertical direction is called an effective visual field, in which information can be accepted instantly by an eyeball movement alone.

Further, a region 208 corresponding to a visual field within 60° to 90° in the horizontal direction and 45° to 70° in the vertical direction is called a stable visual fixation field, and a region 210 corresponding to a visual field within 100° to 200° in the horizontal direction and 85° to 130° in the vertical direction is called an auxiliary visual field. In this manner, the identification ability of information decreases as the distance from the gaze point 202 increases. Taking this characteristic into consideration, the present embodiment is based on an assumption that a region 212 of a predetermined range including the gaze point 202 is represented by a higher resolution than that of a region 214 on the outer side of the region 212 as depicted in (b). To implement this, the region 212 and the region 214 are represented by displaying mechanisms different from each other such that the regions are eventually visually recognized in a synthesized state.

As a displaying mechanism for the region 212 including the gaze point 202, a laser scanning method is adopted in the present embodiment. The laser scanning method is a technology that uses a mirror for deflection to perform two-dimensional scanning with laser light corresponding to a pixel to form an image on a projection face. For example, application of a technology that converges laser light at the pupil of the user to project an image on the retina mainly to a wearable display is underway (for example, refer to PCT Patent Publication No. WO2009/066465). Also, a small-sized projector for projecting an image on an external screen or the like has practically been used (for example, refer to Japanese Patent Laid-open No. 2017-83657).

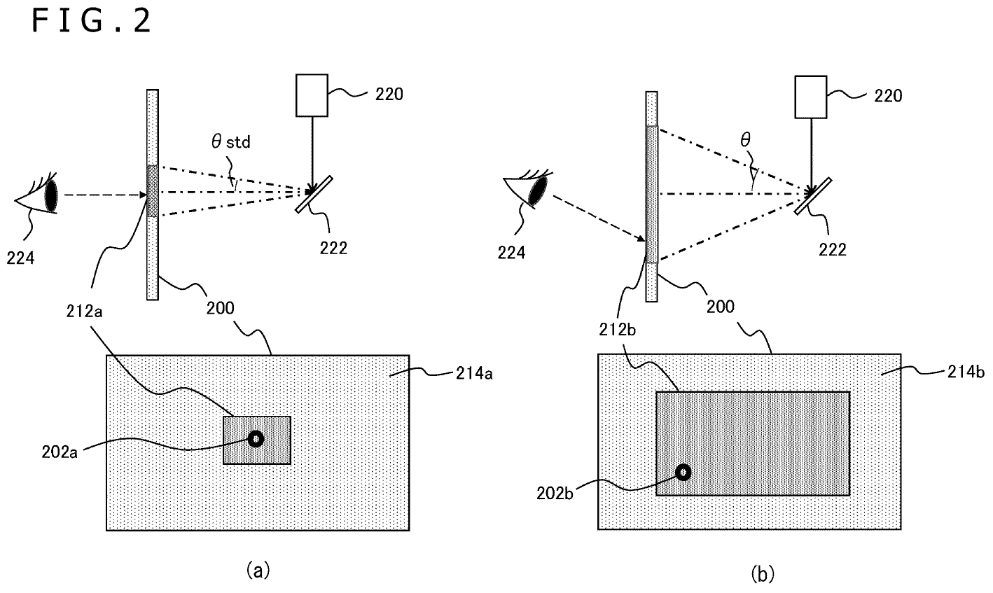

FIG. 2 is a view illustrating a relation between a displaying mechanism of the laser scanning type adopted in the present embodiment and a region on an image. An upper stage of (a) and (b) depicts schematic views of the displaying mechanism of the laser scanning type as viewed from a side. A laser light source 220 outputs laser light including components of red, blue, and green. The laser light is reflected by a mirror 222 and is projected on a projection face (image plane 200).

By rocking the mirror 222 around two axes, two-dimensional scanning with the laser light is performed on the projection face, and an image in which the laser light outputted at each point of time represents a pixel is formed. It is to be noted that, in this example, the mirror 222 is rocked symmetrically with reference to a posture thereof in a state in which reflection light of the laser light reaches the center of the image plane 200. Consequently, the center of a region 212a represented by the laser scanning method coincides with the center of the image plane. However, the present embodiment is not restrictive in this regard.

Further, in FIG. 2, assuming a head-mounted display, an eye 224 of the user is indicated on the opposite side of the projection face such as a screen having permeability. However, drawing may be performed directly on the retina as described hereinabove, and the screen is not essentially required. As the mirror 222, for example, a MEMS (Micro Electro Mechanical Systems) mirror is introduced. A MEMS mirror is a small and low power consumption device that can control the angle change around two axes with high accuracy by electromagnetic driving. However, the driving method for the mirror is not specifically restricted to any kind.

In the present embodiment, the amplitude of the angle of the mirror 222 is changed according to a movement of the gaze point such that, as the gaze point is spaced away from the center of the image plane 200, the size of the region represented by the laser scanning method increases. First, in a case depicted in (a), the gaze point 202a is at the center of the image plane 200 as depicted in FIG. 1. The amplitude of the angle of the mirror 222 at this time, and hence, the amplitude of the scanning angle of the laser light, is used as a reference value θ_{std}. The reference value θ_{std} may be a minimum value determined in advance.

Meanwhile, in a case depicted in (b), a gaze point 202b moves toward the bottom left of the image plane 200. At this time, the amplitude θ of the angle of the mirror 222 is made greater than θ_{std}. In particular, the amplitude θ of the angle of the mirror 222 is increased to expand a region 212b such that an edge of the region 212b represented by the laser scanning method keeps a fixed distance from the gaze point 202b. For example, in a case where the region 212a in a reference state depicted in (a) is to be expanded to n times in the vertical direction, the amplitude θ of the angle can be determined as follows.

tan θ=n×tan(θ_{std})

Naturally, also in expansion in the horizontal direction, the amplitude of the angle of the mirror 222 can be determined similarly.

In the displaying method by laser scanning, in a case where the frame rate is fixed, the scanning angle and the resolution have an inversely proportional relation. In particular, in a case where the region 212a is expanded to n times, the number of pixels per unit angle in the expansion direction is 1/n. Meanwhile, the resolution of the regions 214a and 214b on the outer side represented by a different displaying mechanism may be fixed. With such control as just described, since the gaze point is always in the inside of the regions 212a and 212b represented by the laser scanning method, a boundary portion at which a difference occurs in resolution is less likely to be gazed. Further, as the gaze point approaches an end of the image plane 200, the resolution difference between the regions decreases, and thus, the boundary becomes less likely to be stand out. Therefore, even if the gaze point should exceed a region capable of being represented by laser scanning, the boundary line becomes less likely to be visually recognized.

It is to be noted that, in the reference state depicted in (a), if the reference value θ_{std} is determined according to a common visual characteristic in such a manner that an edge of the region 212a represented by the laser scanning method is placed on the outer side at least of an effective visual field, then the boundary becomes less likely to be visibly recognized even if the resolution has some degree of difference. Consequently, the resolution of the region 212a can be made higher such that a high-quality image can be exhibited without causing a feeling of strangeness. Since such an effect as just described can be obtained naturally by controlling the amplitude of the angle of mirror 222 in a displaying method of the laser scanning type, increase of the processing load can be suppressed.

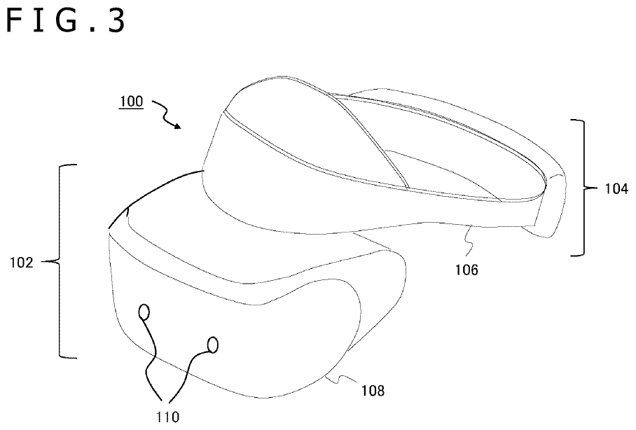

While the display device to which the present embodiment can be applied is not particularly restricted to any kind, the present embodiment is described below taking a head-mounted display as an example. FIG. 3 depicts an example of an appearance of the head-mounted display of the present embodiment. In the present example, the head-mounted display 100 includes an outputting mechanism unit 102 and a wearing mechanism unit 104. The wearing mechanism unit 104 includes a mounting band 106 that surrounds the head of the user when the user wears the head-mounted display to implement fixation of the device. The outputting mechanism unit 102 includes a housing 108 shaped in such a manner as to cover the left and right eyes of the user in a state in which the user is wearing the head-mounted display 100, and includes, in the inside thereof, such a displaying mechanism of the laser scanning type as described above and a mechanism that displays an image in other regions.

The housing 108 further includes, in the inside thereof, a mechanism for synthesizing displayed images in two-regions and an eyepiece for enlarging a visual field angle. Images of a stereo image having parallax therebetween may be displayed individually on the left and right eyes to implement stereoscopic vision. The housing 108 further includes, in the inside thereof, a gaze point detector for detecting a gaze point of a user on a displayed image.

The head-mounted display 100 may further include a speaker or an earphone at a position corresponding to each ear of the user when it is worn. In this example, the head-mounted display 100 includes a stereo camera 110 on a front face of the housing 108 and captures a moving picture of the surrounding real space in a visual field corresponding to the line of sight of the user. The head-mounted display 100 may further include, in the inside or the outside of the housing 108, any of various sensors for deriving a movement, a posture, a position, or the like of the head-mounted display 100 such as an acceleration sensor, a gyroscopic sensor, a geomagnetic sensor, and a GPS (Global Positioning System).

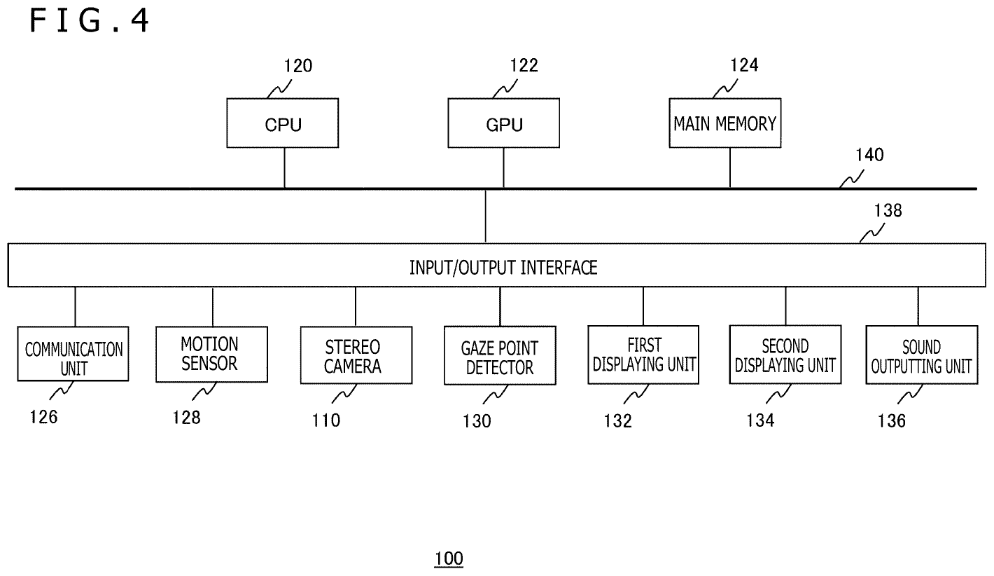

FIG. 4 depicts a configuration of an internal circuit of the head-mounted display 100. The head-mounted display 100 includes a CPU (Central Processing Unit) 120, a GPU (Graphics Processing Unit) 122, and a main memory 124. The components mentioned are connected to each other by a bus 140. An input/output interface 138 is further connected to the bus 140. A communication unit 126, a motion sensor 128, a stereo camera 110, a gaze point detector 130, a first displaying unit 132, a second displaying unit 134, and a sound outputting unit 136 are connected to the input/output interface 138.

The CPU 120 executes an operating system stored in the main memory 124, to control the overall head-mounted display 100. Further, the CPU 120 executes various programs downloaded through the communication unit 126 and reproduces electronic content. The GPU 122 has a function of a geometry engine and a function of a rendering processor, draws a display image in accordance with a drawing command from the CPU 120, and then outputs the drawn image to the first displaying unit 132 and the second displaying unit 134.

The main memory 124 includes a RAM (Random Access Memory) and stores a program and data necessary for processing of the CPU 120 and the like. The communication unit 126 is a network interface of a wired or wireless LAN (Local Area Network), Bluetooth (registered trademark), or the like, and implements communication with an external apparatus. The motion sensor 128 includes at least one of such sensors as an acceleration sensor, a gyro sensor, a geomagnetic sensor, and a GPS, and measures the position, posture, and movement of the head-mounted display 100, and hence the head of the user who is wearing the head-mounted display 100.

As depicted in FIG. 3, the stereo camera 110 is a pair of video cameras that capture an image of the surrounding real space from left and right points of view in a visual field corresponding to the point of view of the user. If a moving picture image captured by the stereo camera 110 is displayed immediately by the first displaying unit 132 and the second displaying unit 134, then what is generally called video see-through which allows a situation of the real space in a direction the user is facing to be seen as it is can be implemented. Further, if a virtual object is drawn on a figure of an actual object in a captured image, then augmented reality can be implemented. Further, if an image captured by the stereo camera 110 is analyzed by a known technology such as Visual SLAM (Simultaneous Localization and Mapping), then the position and the posture of the head-mounted display 100, and hence the head of the user, can be tracked.

An analysis result of the captured image and a measurement result of the motion sensor 128 may be integrated to acquire the movement of the user head with a higher degree of accuracy. This makes it possible to generate a display image in a visual field according to a movement of the head with a high degree of accuracy and enhance the feeling of immersion in the video world. Also, it is possible to accept a movement of the head of the user as a user operation for content and branch processing according to the accepted user operation.

The gaze point detector 130 detects position coordinates of the gaze point of the user who is watching images displayed by the first displaying unit 132 and the second displaying unit 134, at a predetermined rate. The gaze point detector 130 includes, for example, a mechanism that irradiates the eyeballs with an infrared ray and a camera that captures an image of reflection light of the infrared ray, and specifies the direction of the pupil from the captured image to track a point at which the user looks on the image. Various technologies have practically been used as a method for detecting a gaze point, and any one of the various technologies may be adopted in the present embodiment.

The first displaying unit 132 includes a displaying mechanism of the laser scanning type described hereinabove with reference to FIG. 2 and projects and displays an image of a region including the center of the image plane. A partial image displayed by the first displaying unit 132 is hereinafter referred to as a “central image.” The second displaying unit 134 displays an image of a region on the outer side of the central image. A partial image displayed by the second displaying unit 134 is hereinafter referred to as a “peripheral image.” The displaying method of the second displaying unit 134 is not particularly restricted to any kind and may use a display panel including a two-dimensional array of light emitting elements such as a liquid crystal panel or an organic EL (Electroluminescent) panel or may be a displaying mechanism of the laser scanning type similar to that of the first displaying unit 132. In any case, the second displaying unit 134 displays the peripheral image with a lower resolution than that of the central image displayed by the first displaying unit 132.

The first displaying unit 132 and the second displaying unit 134 display a central image and a peripheral image generated by the GPU 122, at a predetermined rate, respectively. The images displayed by the first displaying unit 132 and the second displaying unit 134 are synthesized by a synthesis mechanism hereinafter described and are visually recognized as one display image by the user. It is to be noted that, as described above, stereoscopic vision may be implemented by displaying images of a stereo image on left and right eyes. In this case, the stereo image is a pair of images obtained by synthesizing the central image and the peripheral image. The sound outputting unit 136 includes a speaker or an earphone provided at a position corresponding to each of the ears of the user when the head-mounted display 100 is worn, and outputs sound to be heard by the user.

It is to be noted that some of the functions of the head-mounted display 100 depicted in FIG. 4 may be provided in an external apparatus that establishes communication with the head-mounted display 100. For example, at least part of processes such as a process for determining an appropriate visual field and generating an overall image of it, a process for controlling the boundary between the central image and the peripheral image according to a gaze point, and a process for generating data concerning the central image and the peripheral image may be performed by an external image generation apparatus or an image providing server connected thereto through a network.

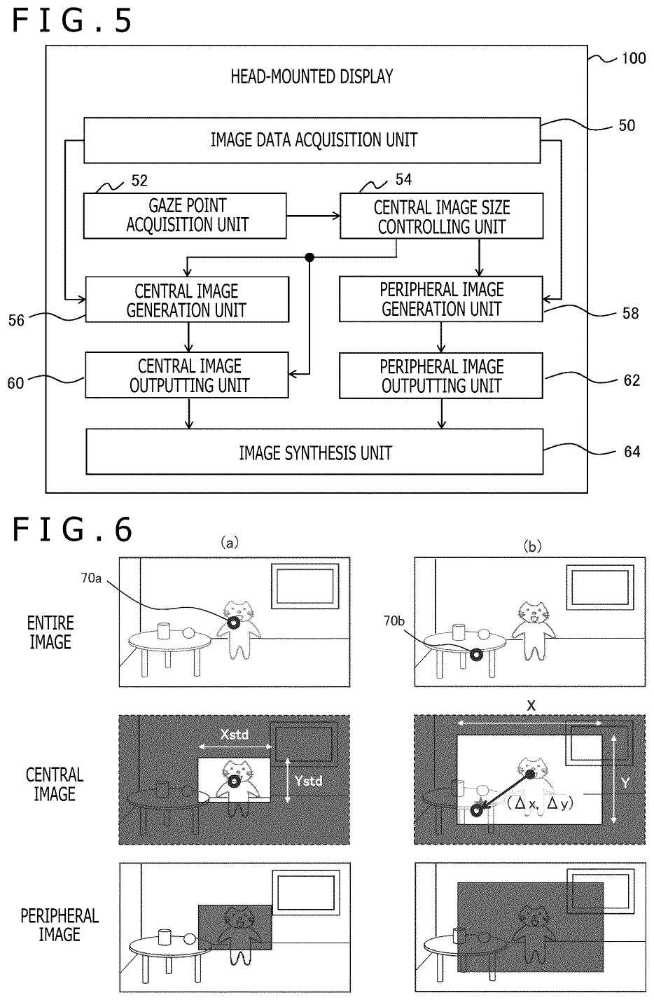

FIG. 5 depicts a configuration of functional blocks of the head-mounted display 100. The functional blocks depicted in FIG. 5 can be implemented in hardware from the various circuits depicted in FIG. 4 and can be implemented in software from a program that is loaded from a recording medium into the main memory 124 and demonstrates various functions such as an information processing function, an image processing function, a displaying function, and a communication function. Accordingly, it can be recognized by those skilled in the art that such functional blocks as described above can be implemented in various forms only from hardware, only from software, or from a combination of them, and none of them is restrictive.

The head-mounted display 100 includes an image data acquisition unit 50 that acquires data concerning an image of a displaying target, a gaze point acquisition unit 52 that acquires a gaze point of a user on the displayed image, a central image size controlling unit 54 that controls the size of a central image, a central image generation unit 56 that generates a central image, a peripheral image generation unit 58 that generates a peripheral image, a central image outputting unit 60 that outputs the central image as a displaying target, a peripheral image outputting unit 62 that outputs the peripheral image as a displaying target, and an image synthesis unit 64 that causes the central image and the peripheral image to reach in a synthesized state the eyes of a user.

The image data acquisition unit 50 acquires data necessary for generation of a moving image or a still image to be displayed. The substance to be represented by the image here is not specifically restricted to any kind and may be any of a game image, a movie, a live video, a recorded video, an animation, a photograph, an environmental video, a web site, a document, a digital signage, and so forth. Otherwise, the substance may be an image captured by the stereo camera 110, a processed image of the image, or an image in which a virtual object is drawn. Depending upon the substance of the image, the image data acquisition unit 50 may acquire data from various units.

For example, the image data acquisition unit 50 may acquire data concerning a moving image transferred thereto as a stream from an external image generation apparatus or server or may draw or reproduce an image with use of data stored in an internal storage device. The gaze point acquisition unit 52 includes the gaze point detector 130 depicted in FIG. 4 and acquires position coordinates of a gaze point of a user on a display image at a predetermined rate. Note that it is sufficient if the display image in the present embodiment is an image in sight of the user, and also projection of laser light is represented as “display.”

The central image size controlling unit 54 controls the size of the central image according to the position of the gaze point of the user. In particular, a state in which the gaze point is at the center of the image plane is determined as a reference state as described hereinabove with reference to FIG. 2, and the range of the central image is expanded such that the central image includes the gaze point according to the movement of the gaze point. As a result, the central image expands as the gaze point moves away from the center and decreases as the gaze point moves toward the center. The central image size controlling unit 54 determines the size of the central image at a predetermined rate or as needed, and supplies information concerning the size to the central image generation unit 56, the peripheral image generation unit 58, and the central image outputting unit 60.

The central image generation unit 56 includes the GPU 122 depicted in FIG. 4 and acquires necessary data from the image data acquisition unit 50 to generate a central image. Also the peripheral image generation unit 58 includes the GPU 122 depicted in FIG. 4 and acquires necessary data from the image data acquisition unit 50 to generate a peripheral image. Here, the peripheral image is an image in which a region of the central image is blacked out (invalidated) from the entire display image. The boundary between the central image and the peripheral image is updated suitably according to information from the central image size controlling unit 54.

The central image outputting unit 60 includes the first displaying unit 132 depicted in FIG. 4 and displays the central image generated by the central image generation unit 56, at a predetermined rate by laser scanning. Particularly, the central image outputting unit 60 determines an amplitude of the angle of the mirror around each of the two axes according to the size of the central image notified from the central image size controlling unit 54. Further, the central image outputting unit 60 performs two-dimensional scanning with laser light representative of a color of each pixel of the central image with a scanning angle corresponding to the amplitude to project the laser light on the retina of the user, a screen in front of the user, or the like.

The peripheral image outputting unit 62 includes the second displaying unit 134 depicted in FIG. 4 and displays a peripheral image on a display panel including light emitting elements or by laser scanning. In a case where a display panel is used, the region of the central image does not emit light. In a case where the laser scanning method is used, laser light is not outputted to the region of the central image. In any case, the density of pixels for displaying a peripheral image is fixed irrespective of the size of the central image.

The image synthesis unit 64 is an optical system that synthesizes a displayed central image and peripheral image such that they reach the eyes as one image. In other words, the image synthesis unit 64 is a hardware structure that synthesizes and indicates the central image and the peripheral image without any offset therebetween and can take various forms depending upon the positional relation between the first displaying unit 132 and the second displaying unit 134, arrangement required for the gaze point detector 130, and so forth.

FIG. 6 schematically depicts a change in a central image and a peripheral image by a movement of the gaze point. In FIG. 6, the upper stage depicts an entire display image; the middle stage depicts a central image; and the lower state depicts a peripheral image. It is to be noted that each of the central image and the peripheral image is depicted such that the range of the region thereof with respect to the entire image is represented by coloring the outside of the range with a dark color and does not indicate the size of the image as data. In a case where a gaze point 70a is at the center of the entire image as depicted in (a), the central image is a region of a predetermined size (X_{std}, Y_{std}) centered at the gaze point 70a, and the peripheral image is a region of the entire image from which the region of the central image is removed.

Here, in a strict sense, the size (X_{std}, Y_{std}) of the central image is determined preferably in reference to the relation between the angle and the visual acuity when the line of sight is taken as the center axis as descried hereinabove with reference to FIG. 1. In contrast, in a case where a gaze point 70b is displaced from the center on the image plane as depicted in (b), the central image is expanded in such a manner as to include the gaze point 70b. For example, when the displacement vector of the gaze point from the image center is (Δx, Δy), the size (X, Y) of the central image is determined in the following manner.

$$X = 2 ⋆ ( \vert Δ x \vert + {m}_{x} )$$

$$Y = 2 ⋆ ( \vert Δ y \vert + {m}_{y} )$$

Here, mₓ and m_{y} are margins to be provided to distances between two sides positioned most proximately to the gaze point from within an edge of the central image and the gaze point. In other words, the edge of the central image is controlled in such a manner as to normally be positioned on the outer side at least by (mₓ, m_{y}) from the gaze point. Also, for (mₓ, m_{y}), a determination rule is preferably prepared in advance according to the relation between the angle when the line of sight is taken as the center axis and the visual acuity. For example, (mₓ, m_{y}) may be set to (mₓ, m_{y})=(X_{std}/2, Y_{std}/2). Alternatively, (mₓ, m_{y}) may be made a function of the displacement vector (Δx, Δy). Also in this case, the peripheral image is determined as a region of the entire image from which the region of the central image is removed.

It is to be noted that the central image size controlling unit 54 may update the size of the central image at any time in response to a change in the displacement vector of the gaze point or may update the size of the central image stepwise when the displacement vector changes by an amount equal to or greater than a threshold value or in a like case. In a case where an image is to be made look stereoscopic, the central image generation unit 56 and the peripheral image generation unit 58 generate such a central image and a peripheral image as depicted in FIG. 6 for each of the image for the left eye and the image for the right eye, respectively. Further, the central image generation unit 56 and the peripheral image generation unit 58 generate a central image and a peripheral image, respectively, to which distortion in a direction opposite to that of distortion aberration or chromatic aberration by the eyepiece of the head-mounted display 100 is provided, so that an image having no distortion and no color shift is visually recognized when they are viewed through the eyepiece. Further, depending upon the configuration of the first displaying unit 132, the shape of the central image is not restricted to a rectangular shape, and naturally, also the shape of the blacked region of the peripheral image depends upon the shape of the central image.

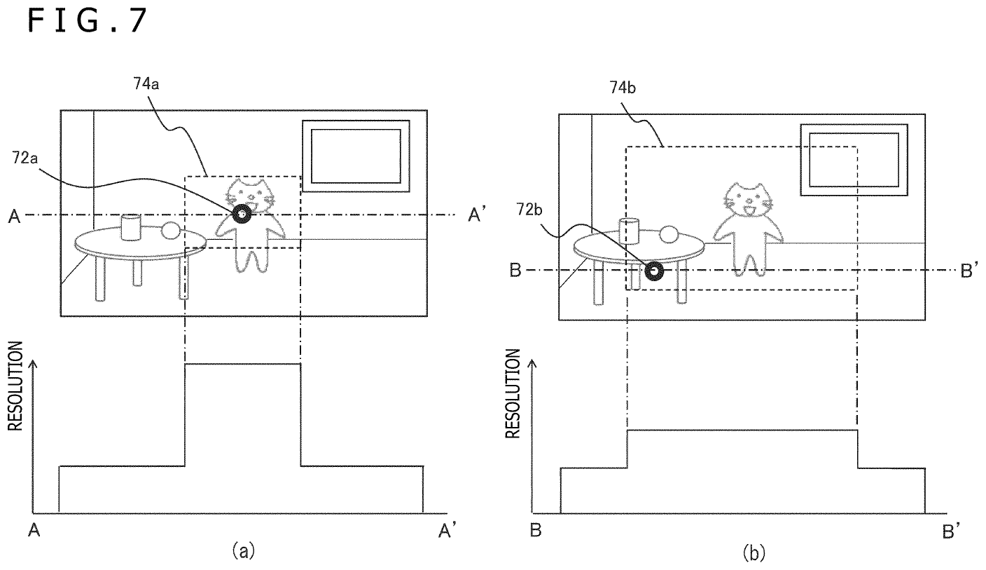

FIG. 7 depicts views illustrating a change in the resolution with respect to the size of the central image. The upper stage of FIG. 7 depicts an entire display image, and (a) depicts a reference state in which a gaze point 72a is at the center while (b) depicts a state in which a gaze point 72b is displaced from the center on the image plane. The lower stage of FIG. 7 depicts distributions of the resolution along horizontal directions AA′ and BB′ passing the gaze points 72a and 72b on the image plane, respectively. If a central image 74b expands as depicted in (b) of FIG. 7 in comparison with a central image 74a of a minimum size in the reference state depicted in (a), the resolution at the portion decreases.

The term “resolution” here indicates not the fineness of an image on data but a drawn number of physical images per unit area (or unit angle), that is, a pixel density. The displaying mechanism of the laser scanning type has such a characteristic that the resolution increases as the projection area decreases as described hereinabove. For example, in a case of a device that can display an image of 600 pixels within a range of an angular field of view of 30° in the horizontal direction, the angular resolution is 20 ppd (pixel per degree). If the amplitude of the angle of the mirror is decreased to one half in this state, since an image of 600 pixels is displayed similarly within the range of the angular field of view of 15°, the angular resolution is 40 ppd.

Owing to this characteristic, in the central image 74a of the minimum size depicted in (a), the resolution in the portion is maximum, and as the size of the central image 74b increases, the resolution decreases as depicted in (b). Since the user looks at the image centered at the gaze point 72a or 72b, as the line of sight moves in a direction toward an end of the image, the resolution decreases such that the central image looks as if it is continuing smoothly to the peripheral image. Further, since the peripheral image continues to be displayed with a fixed resolution with which the image is worth viewing, the range of the field of view is maintained. As a result, in whatever manner the gaze point is displaced, it is possible to allow an image of a wide field of view to continue to be visually recognized in high definition while the sense of strangeness to be provided by the boundary of the region is minimized.

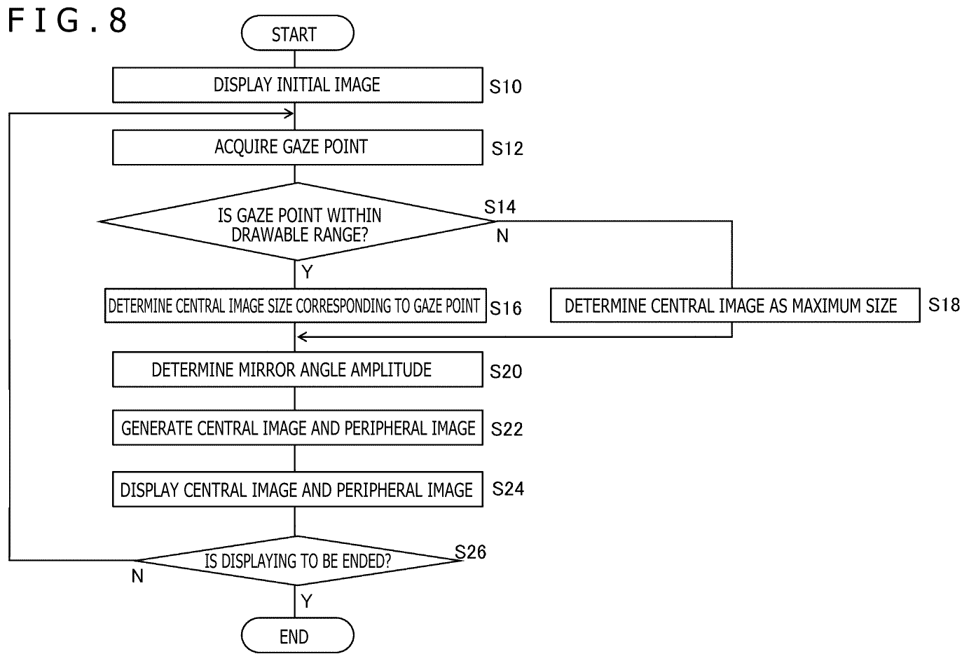

Now, actions of the head-mounted display 100 that can be implemented by the configuration described above are described. FIG. 8 is a flow chart depicting a processing procedure when the head-mounted display 100 of the present embodiment displays an image. This flow chart is started when a user wears the head-mounted display 100 and selects content of a displaying target through an unillustrated inputting device or the like. In response to this, the image data acquisition unit 50 starts acquisition of image data of the content. It is to be noted that, although the head-mounted display 100 may perform information processing of a game or the like in the inside thereof or may establish communication with an external apparatus and issue a request for image data, FIG. 8 particularly depicts a displaying process of an image.

First, the head-mounted display 100 displays an initial image of the content (S10). Also, the initial image may be an image obtained by synthesizing a central image displayed by the central image outputting unit 60 and a peripheral image displayed by the peripheral image outputting unit 62, and the central image in this case may have a size set in advance for the initial image. Next, the gaze point acquisition unit 52 acquires a gaze point of the user in the initial image (S12). Consequently, the central image size controlling unit 54 first checks whether or not the gaze point is within a drawable range of the central image outputting unit 60, that is, by laser scanning for displaying the central image (S14).

In the case where the gaze point is within the drawable range of the central image outputting unit 60 (Y in S14), the central image size controlling unit 54 determines a size for the central image according to the position of the gaze point as depicted in FIG. 6 (S16). In a case where the gaze point is outside the drawable range of the central image outputting unit 60 (N in S14), the central image size controlling unit 54 determines the central image to have a maximum size, that is, to be within a drawable maximum range (S18). Consequently, the resolution of the central image becomes lowest, and the possibility that the difference from the resolution of the peripheral image may be visually recognized unnatural is suppressed. It is to be noted that, when the gaze point is on the peripheral image, the resolution may be uniformized by adopting a configuration for unifying the minimum value of the resolution of the central image and the resolution of the peripheral image.

The central image size controlling unit 54 notifies the central image outputting unit 60 of the determined size for the central image at any time such that an amplitude of the angle of the MEMS mirror corresponding to the size is set (S20). Meanwhile, the central image generation unit 56 and the peripheral image generation unit 58 acquire necessary data from the image data acquisition unit 50 to generate a central image and a peripheral image, respectively, in reference to the size for the central image notified from the central image size controlling unit 54 (S22). Then, the central image outputting unit 60 and the peripheral image outputting unit 62 display the central image and the peripheral image, respectively, such that a display image synthesized by the image synthesis unit 64 reaches the eyes of the user (S24).

During a period in which the display need not be ended because a user operation for ending the display of the content or the like is performed, the processes in S12 to S24 are repeated (N in S26). Consequently, the image displaying is continued while the range of the central image and the resolution are changed by a movement of the gaze point. If it becomes necessary to end the display, then all processes are ended (Y in S26).

Now, a particular structure for synthesizing a central image and a peripheral image to form an image to be visually recognized is described. FIG. 9 depicts an example of a structure of the image synthesis unit 64 that synthesizes a central image and a peripheral image to form an image to be visually recognized in the head-mounted display 100 of the present embodiment. FIG. 9 schematically depicts, in a cross-sectional view taken in the vertical direction, a positional relation between an eye 224 of a user when the head-mounted display 100 is worn by the user and a display unit including the first displaying unit 132 and the second displaying unit 134. This similarly applies also to the description given hereinbelow with reference to FIGS. 10 to 13.

In the mode of FIG. 9, as the first displaying unit 132, a central image screen 232 including a member that diffuses and transmits reflected laser light is provided together with the laser light source 220 and the mirror 222. Meanwhile, as the second displaying unit 134, a peripheral image display panel 234 including a two-dimensional array of light emitting elements is provided. Further, the angle defined by the central image screen 232 and the peripheral image display panel 234 is set to 90°, and a central image and a peripheral image are synthesized by a half mirror 236 arranged intermediately between the central image screen 232 and the peripheral image display panel 234 to define 45° with respect to each of them. The half mirror 236 is a general one that transmits a predetermined ratio of incident light therethrough and reflects the remaining part of the incident light.

In the example depicted in FIG. 9, laser light reflected by the mirror 222 is diffused and transmitted by the central image screen 232, is transmitted through the half mirror 236, and reaches the eye 224 through the eyepiece 238. In particular, the first displaying unit 132 controls the action and so forth of the mirror 222 such that an original figure is represented in a state in which the laser light is diffused and transmitted by the central image screen 232. Meanwhile, light from the peripheral image display panel 234 is reflected by the half mirror 236 and reaches the eye 224 through the eyepiece 238. Consequently, the central image and the peripheral image are visually recognized in a synthesized state.

It is to be noted that the positional relation of the first displaying unit 132 and the second displaying unit 134 may be reversed such that laser light from the mirror 222 is reflected by the half mirror 236 while light from the peripheral image display panel 234 is transmitted to reach the eye 224. Further, in place of the peripheral image display panel 234, a peripheral image may be displayed by a laser scanning method. In any case, in this configuration, an eyeball imaging camera 240, which is included in the gaze point detector 130, may be arranged next to the eyepiece 238 or the like as depicted in FIG. 9.

FIG. 10 depicts another example of a structure of the image synthesis unit 64 that synthesizes a central image and a peripheral image to form an image to be visually recognized in the head-mounted display 100 of the present embodiment. The present configuration is different from that in FIG. 9 in that a central image screen is not provided as the first displaying unit 132 while an image formed from laser light is projected directly on the retina of the user. To a technique for projecting a screen image on the retina by the Maxwell's principle of vision, a known technology can be applied as described hereinabove. In short, the first displaying unit 132 controls the action and so forth of the mirror 222 such that, when laser light is converged at the pupil and forms an image on the retina, an original figure can be visually recognized.

It is to be noted, however, that, in the present embodiment, the central image is projected through the half mirror 236 to be synthesized with the peripheral image displayed on the peripheral image display panel 234 and reflected by the half mirror 236 and form an image to be visually recognized. It is to be noted that, in this case, since a central image screen is not provided, the degree of freedom in arrangement of the eyeball imaging camera 240 included in the gaze point detector 130 increases. For example, it becomes possible to capture an image of an eyeball from the proximity of the front through the half mirror 236 as depicted in FIG. 10.

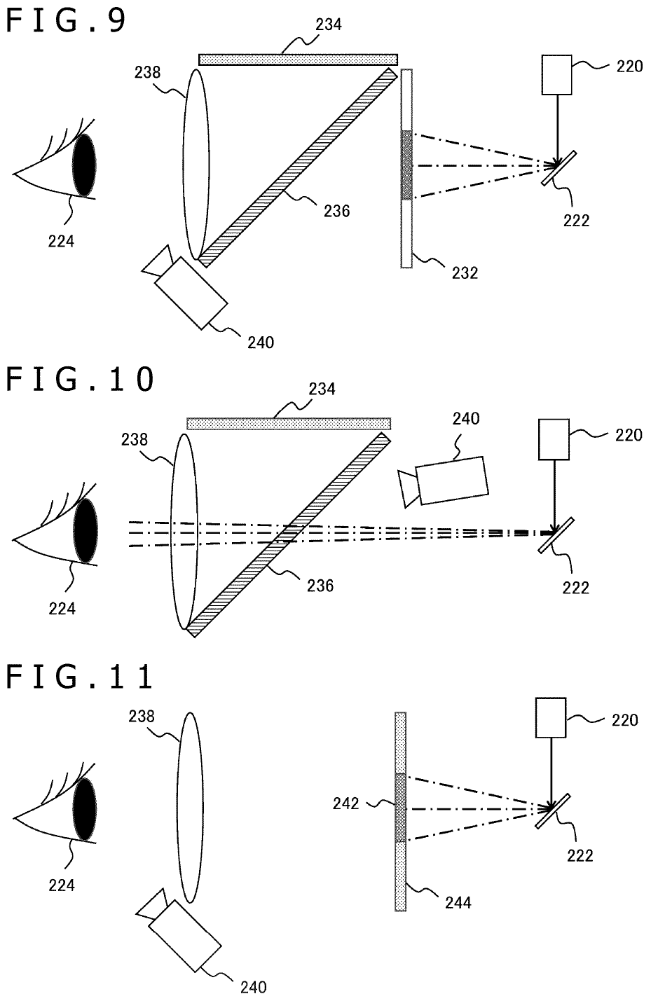

FIG. 11 depicts a further example of a structure of the image synthesis unit 64 that synthesizes a central image and a peripheral image to form an image to be visually recognized in the head-mounted display 100 of the present embodiment. This configuration is different from that of FIG. 9 in that a central image screen 242 that diffuses and transmits laser light of the first displaying unit 132 is provided integrally with a peripheral image display 244 while no half mirror is provided. There is known a light transmission type display which can transmit, in a region (non-displaying region) thereof in which no image is displayed within a display panel, light from the background (for example, refer to PCT Patent Publication No. WO2014/010585). In the present embodiment, this is applied such that a base material of a light transmission type display that includes a translucent material is used as the peripheral image display 244.

Consequently, a region of the peripheral image display 244 in which a peripheral image is not displayed can be used as the central image screen 242 that diffuses and transmits laser light reflected by the mirror 222. Naturally, since also the range of the peripheral image changes according to a size change of the central image, the range of the central image screen 242 changes appropriately according to the size of the central image. It is to be noted that, in this case, part of the central image outputting unit 60 and the peripheral image outputting unit 62 serves as the image synthesis unit 64. Adopting such a configuration as just described allows the optical system to be simplified in comparison with an alternative configuration that projects two different images from different directions. In the present configuration, the eyeball imaging camera 240 included in the gaze point detector 130 may be arranged next to the eyepiece 238 or the like as in FIG. 9.

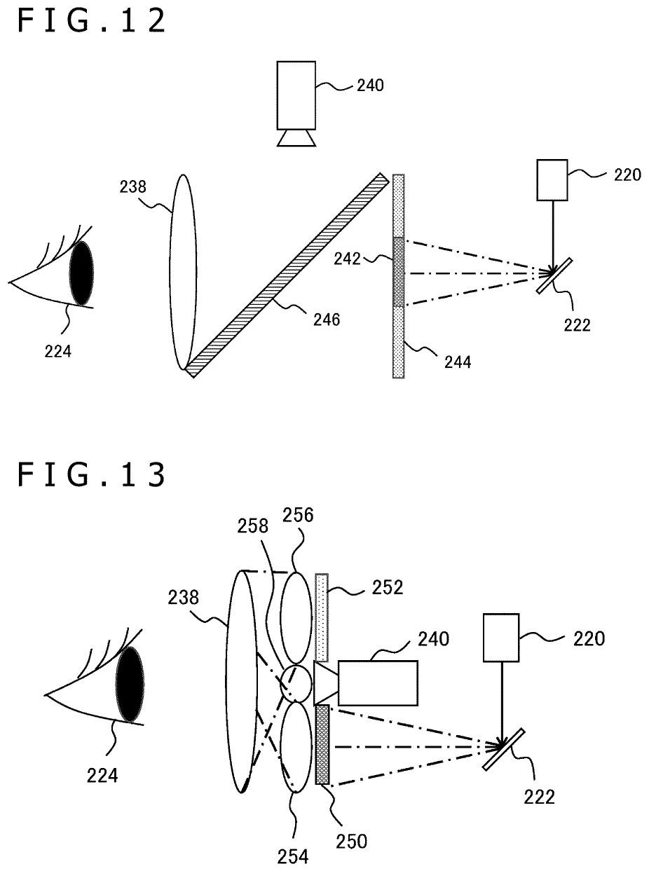

FIG. 12 depicts a still further example of a structure of the image synthesis unit 64 that synthesizes a central image and a peripheral image to form an image to be visually recognized in the head-mounted display 100 of the present embodiment. In the present configuration, a light transmission type display is applied such that the central image screen 242 and the peripheral image display 244 are provided integrally as in FIG. 11. Meanwhile, the configuration is different from that of FIG. 11 in that a half mirror 246 is provided between the central image screen 242 and the peripheral image display 244 and the eyepiece 238. In particular, light from the central image screen 242 and the peripheral image display 244 is allowed to be visually recognized through the half mirror 246. Although this configuration decreases the light amount of an image, if the half mirror 246 is arranged in such a manner as to form an angle of 45° with respect to the plane of the eye 224, since a figure of the eye 224 can be captured by the eyeball imaging camera 240 through reflection by the half mirror 246, a gaze point can be detected with quality equal to that by capturing an image from the front.

FIG. 13 depicts a yet further example of a structure of the image synthesis unit 64 that synthesizes a central image and a peripheral image to form an image to be visually recognized in the head-mounted display 100 of the present embodiment. In this configuration, although a central image screen 250 and a peripheral image display panel 252 are provided separately from each other as in FIG. 9, they are arranged in substantially the same plane while different figures are introduced in appropriate directions by a central image optical system 254 and a peripheral image optical system 256 to implement image synthesis.

A technology of introducing an optical system of a freeform surface into a head-mounted display such that images displayed on a plurality of displays are guided to an appropriate position by reflection and refraction and the images are visually recognized as one image is disclosed, for example, in PCT Patent Publication No. WO2019/147946. With this configuration, the head-mounted display 100 can be scaled down in comparison with that of an alternative configuration that projects two different images from different directions. Further, since the light path can be designed relatively freely, the degree of freedom in arrangement of the eyeball imaging camera 240 can be increased.

For example, by arranging the central image screen 250 and the peripheral image display panel 252 as well as optical systems 54 and 256 thereof away from the front of the eye 224 as depicted in FIG. 13, an eyeball imaging optical system 258 and the eyeball imaging camera 240 can be arranged in front of the eye 224. This makes it easy to detect a gaze point. It is to be noted that the position and the posture of the central image screen 250 and the peripheral image display panel 252 may have variation by design of the central image optical system 254 and the peripheral image optical system 256.

With the present embodiment described above, a display image is divided into a central image and a peripheral image, and the central image and the peripheral image are displayed by individual mechanisms such that the central image is represented in a higher resolution and are then synthesized to form an image to be visually recognized. Here, at least the displaying mechanism for displaying the central image is made a displaying mechanism of the laser scanning type that performs two-dimensional scanning with laser light by reflection of a mirror to form an image. With the laser scanning method, the displaying range and the resolution as a density of pixels representative of the display range can be changed by controlling the amplitude of the angle of the mirror. Accordingly, the distribution of resolution on a display image can be controlled readily in comparison with that on a display panel in which the density of light emitting elements is fixed.

For example, the amplitude of the angle of the mirror is changed such that, as the gaze point of the user moves away from the center of the image plane, the central image is expanded to a range that includes the gaze point. By this, the boundary line between the central image and the peripheral image is spaced away from the gaze point without depending upon the position of the gaze point, and the resolution difference at the boundary becomes less likely to be recognized. Further, since the resolution decreases together with the expansion of the central image, also the actual resolution difference decreases. As a result, an image having a distribution of resolution can be recognized without a sense of strangeness while a high-load process such as processing of image data is not involved. Consequently, owing to visual characteristics, it is possible to concentrate resources in a region of high identification ability and to allow even an image of a wide field of view to be demonstrated with low delay and with high definition.

The present invention has been described in reference to the embodiment. The embodiment described above is illustrative, and it can be recognized by those skilled in the art that various modifications are possible in the components and the processes thereof and that also such modifications fall within the scope of the present invention.

For example, an embodiment of the present invention can be applied not only to a head-mounted display but also to a projector, a general television receiver, and so forth. Also in those cases, the internal structure may be similar to that in any of FIGS. 9, 11, 12, and 13. In a case of a projector, a projection lens for projecting an image on an external screen or the like is provided in place of the eyepiece 238. In a case of a television receiver, a screen that transmits a figure therethrough is used as a display face in place of the eyepiece 238. Alternatively, according to the configuration of FIG. 11, a light transmission type display that implements the peripheral image display 244 can be used as it is.

In those cases, the gaze point detector naturally includes a camera for capturing an image of an eyeball in a direction toward the eye of the user who is watching the screen or the display face. It is to be noted that, although, in the present embodiments, the size of the central image is controlled according to a movement of the gaze point, the size may be controlled otherwise according to, in place of the gaze point, the displaying position of a principal object or a position that is important in displaying such that the gaze point is included in the central image. Since the possibility that a principal object or an important region may be gazed is high, even if such control as just described is applied, it can be expected that similar advantageous effects to those by the present embodiments are achieved.

### INDUSTRIAL APPLICABILITY

As described above, the present invention can be applied to a displaying device such as a head-mounted display, a projector, or a television receiver, an image display system that includes at least one of them, and so forth.

### REFERENCE SIGNS LIST

50: Image data acquisition unit
52: Gaze point acquisition unit
54: Central image size controlling unit
56: Central image generation unit
58: Peripheral image generation unit
60: Central image outputting unit
62: Peripheral image outputting unit
64: Image synthesis unit
100: Head-mounted display
110: Stereo camera
120: CPU
122: GPU
124: Main memory
130: Gaze point detector
132: First displaying unit
134: Second displaying unit

1. An image displaying device comprising:
a central image generation unit that generates a central image representative of a central portion of a display image on an image plane;
a peripheral image generation unit that generates a peripheral image representative of a region of the display image on an outer side of the central image;
a central image outputting unit that displays the central image by a laser scanning method of performing two-dimensional scanning with laser light representative of a pixel by reflection of a mirror to project an image;
a peripheral image outputting unit that displays the peripheral image; and
an image synthesis unit that synthesizes the central image and the peripheral image to form an image to be visually recognized.

2. The image displaying device according to claim 1, further comprising:
a central image size controlling unit that controls a size of the central image, wherein
the central image outputting unit changes amplitude of an angle of the mirror according to the size of the central image determined by the central image size controlling unit.

3. The image displaying device according to claim 2, further comprising:
a gaze point acquisition unit that acquires a gaze point of a user on the display image,
wherein the central image size controlling unit expands the central image as the gaze point moves away from the center of the image plane such that the gaze point is included in the central image.

4. The image displaying device according to claim 3, wherein the central image size controlling unit sets, in a state in which the gaze point exceeds an upper limit of a range in which the central image outputting unit is able to display, the size of the central image to the upper limit.

5. The image displaying device according to claim 1, wherein the image synthesis unit includes a half mirror that transmits one of a figured displayed by the central image outputting unit and a figure displayed by the peripheral image outputting unit and reflects the other of the figures to synthesize the figures.

6. The image displaying device according to claim 5, wherein
the central image outputting unit includes a screen that diffuses and transmits the laser light reflected by the mirror, and
the image synthesis unit synthesizes a figure diffused and transmitted by the screen with a figure displayed by the peripheral image outputting unit by the half mirror.

7. The image displaying device according to claim 5, wherein
the central image outputting unit projects laser light representative of the central image to be visually recognized by the Maxwell's principle of vision in a direction toward an eye of a user, and
the image synthesis unit transmits the laser light and reflects a figure displayed by the peripheral image outputting unit by the half mirror to synthesize the figures and form an image to be visually recognized.

8. The image displaying device according to claim 1, wherein
the peripheral image outputting unit displays the peripheral image by a light transmission type display that transmits light of a background in a non-displaying region, and
the central image outputting unit projects the laser light reflected by the mirror to a corresponding region of the light transmission type display such that the laser beam is diffused and transmitted.

9. The image displaying device according to claim 8, further comprising:
a half mirror that transmits light from the light transmission type display and reflects a figure of an eyeball of a user; and
a camera for capturing a figure of the eyeball reflected by the half mirror, to acquire a gaze point.

10. The image displaying device according to claim 1, wherein
the central image outputting unit includes a screen that diffuses and transmits the laser light reflected by the mirror, and
the image synthesis unit synthesizes, by a freeform surface optical system that guides a figure diffused and transmitted by the screen and a figure displayed by the peripheral image outputting unit, the two figures.

11. The image displaying device according to claim 10, further comprising:
a camera for capturing an image of an eyeball of a user in a direction toward a front of an eyeball of a user to acquire a gaze point,
wherein the screen and a display panel that configures the peripheral image outputting unit are arranged around the camera.

12. An image displaying method comprising:
generating a central image representative of a central portion of a display image on an image plane;
generating a peripheral image representative of a region of the display image on an outer side of the central image;
displaying the central image by a central image outputting unit of a laser scanning type of performing two-dimensional scanning with laser light representative of a pixel by reflection of a mirror to project an image;
displaying the peripheral image by a peripheral image outputting unit; and
synthesizing the central image and the peripheral image to form an image to be visually recognized.
